(19) United States
(12) Patent Application Publication
(10) Pub. No.: US 2010/0245035 A1
(43) Pub. Date: Sep. 30, 2010

(54) ELECTRONIC TAG BROADCASTING SYSTEM AND BROADCASTING METHOD USING ELECTRONIC TAG

(75) Inventors: Jong Hong Jeon, Daejeon (KR); Won Suk Lee, Daejeon (KR); Kang Chang Lee, Daejeon (KR); Seung Yun Lee, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon-City (KR)

(21) Appl. No.: 11/993,747

(22) PCT Filed: Dec. 22, 2005
(86) PCT No.: PCT/KR2005/004440

§ 371 Date: Dec. 21, 2007

(30) Foreign Application Priority Data
Jun. 24, 2005 (KR) 10-2005-0055097

(51) Int. Cl. G05B 19/00; H04Q 5/22

(52) U.S. Cl. 340/5.8; 340/10.1

(57) ABSTRACT

An electronic tag broadcasting system and a broadcasting method using an electronic tag are provided. The electronic tag broadcasting system makes it possible to include information on photographed objects in a broadcasting signal, greatly change the combination of information by means of conventional manual operations, increase benefits of bi-directional broadcasting and the combination of broadcasting/communication by using recognition information included in broadcasting contents, and create a lot of new products and a large market. Popularity of broadcasting increases usage of electronic tags and their related application, thereby providing various service convergence that combines RFID, USN, communication, broadcasting, etc. and leading to a convenient ubiquitous society.

This application claims the benefit of Korean Patent Application No. 10-2005-0055097, filed on Jun. 24, 2005, in the Korean Intellectual Property Office, the disclosure of which is incorporated herein in its entirety by reference.

### BACKGROUND OF THE INVENTION

1. Field of the Invention

The present invention relates to telecommunication, and more particularly, to an electronic tag broadcasting system and a broadcasting method using an electronic tag.

2. Description of the Related Art

Conventionally, barcodes are attached to objects to present and utilize information on the objects. However, barcodes are restricted to an amount of recorded information, probability of damage/deterioration/forgery, recognizable distances, etc.

Recently, radio frequency identification (RFID) which is a new electronic tag technology has been suggested as a replacement for conventional barcode technology. Although a RFID tag, which is an electronic tag and is an automatic recognition technology, performs a similar function to barcodes and smart cards, it can be sued over long distances, can serve as a shock-absorber, and can recognize several objects simultaneously. Therefore, RFID tags have wider applications than barcodes and smart cards.

A RFID system is classified according to frequency regions. A low frequency RFID system (30˜500 KHz) can recognize a short distance but does not cost much, whereas a high frequency RFID system (800˜950 KHz, 2.4˜2.5 GHz) can recognize a long distance and provide a high recognition speed but costs more and cannot recognize covered objects.

An RFID system does not require a separate automatic recognition system and can coexist with or supplement other automatic recognition systems. RFID systems can be applied in diverse fields including broadcasting.

With the development of broadcasting technology, intellectual bi-directional broadcasting is required to provide various object information including, for example, a hero's costume, accessories, furniture, etc., which are included in a currently broadcasting image. However, there is no conventional technical method to automatically input a variety of additional information.

Conventionally, a contents production tool for data broadcasting is used to produce data in real time or a programming language proportionate to the standard is used for a programmer and designer to produce data broadcasting contents. In this regard, it is substantially impossible to update and transmit data manually or in real time during the contents lifetime. Even if the data is partly updated and transmitted, a production tool dedicated to produce data broadcasting contents including real time data information and establish a relationship between real time data and a system for automatically updating the real time data contents are absolutely required.

A conventional method of producing data broadcasting contents must produce a real time application for producing data broadcasting contents including real time data and a real time operating system necessary for the real time application using a programming language whenever the real time application and operating system are required. Also, since the processing of the real time data for the data broadcasting contents is programmed by an expert, it is difficult to produce the data broadcasting contents including the real time data information.

Data broadcasting requires programming that enables contents including the real time data in the data broadcasting contents to be transmitted and updated in real time. However, since a system for managing and processing the real time data is not provided, it is difficult to process the data in real time.

Conventional real time data broadcasting prepares additional information related to a scheduled broadcasting scenario and transmits a broadcasting signal including audio/video signals, or edits the broadcasting signal via a manual operation.

However, in conventional real time data broadcasting is disadvantageous in that all additional information is prepared for a scheduled procedure, real time updated additional information is automatically reflected, and manual operations of many experts are required to provide even restricted real time services.

### SUMMARY OF THE INVENTION

The present invention provides an electronic tag broadcasting system capable of automatically providing broadcasting data with real time data, and a broadcasting method using an electronic tag.

According to an aspect of the present invention, there is provided an electronic tag broadcasting system, comprising: an electronic tag comprising a recognition number and, when sensing a signal having a predetermined frequency band, transmitting the recognition number; a reader outputting the signal having the predetermined frequency band and reading data from the electronic tag that responds to the signal so as to read information stored in the electronic tag corresponding to an object included in a screen obtained by photographing the object and its surroundings; and a broadcasting signal generator combining the photographed image and an audio signal with the electronic tag's own recognition number and the data read from the reader, multiplexing the combined information, and generating a broadcasting signal.

The electronic tag may transmit information on an object neighboring the electronic tag if the information is previously stored in the electronic tag, wherein the reader reads the information on the neighboring object, and wherein the broadcasting signal generator combines the information on the neighboring object with the photographed image, the audio signal, and the electronic tag's own recognition number, multiplexes the combined information, and generates the broadcasting signal.

According to another aspect of the present invention, there is provided an electronic tag broadcasting system that receives a broadcasting signal obtained by encoding a recognition number of an electronic tag neighboring a photographing object and electronic tag related data which is information on the photographing object stored in the electronic tag along with a photographing image and an audio signal, multiplexing the encoded data, and transmitting the multiplexed data, the broadcasting system comprising: a demultiplexer receiving the multiplexed broadcasting signal and demultiplexing the received broadcasting signal into an image, an audio signal, and electronic tag-related data; and a reproducer reproducing the demultiplexed image and audio signal and simultaneously displaying information on the photographed object on a reproduction screen according to the electronic tag's recognition number.

According to still another aspect of the present invention, there is provided a broadcasting method of recognizing an electronic tag that comprises a recognition number, previously stores information on an object neighboring the electronic tag, and, when sensing a signal having a predetermined frequency band, transmitting the electronic tag's recognition number and the information on the object neighboring the electronic tag, the method comprising: (a) outputting the signal having the predetermined frequency band so as to read information stored in the electronic tag corresponding to an object included in a screen obtained by photographing the object neighboring the electronic tag; (b) receiving electronic tag related data from the electronic tag in response to the signal having the predetermined frequency band; (c) combining the photographed image and an audio signal with the electronic tag's own recognition number and the electronic tag related data received in operation (b), multiplexing the combined information, and generating a broadcasting signal; (d) transmitting the generated broadcasting signal via a communication network including a satellite, a ground wave, a CCTV, DMB, a mobile communication network, and an Internet network; (e) receiving the transmitted broadcasting signal and demultiplexing the received signal into an image, an audio signal, and electronic tag-related data; and (f) reproducing the demultiplexed image and audio signal and simultaneously displaying information on the photographed object on a reproduction screen according to the electronic tag's own recognition number.

The method may further comprise: (g) transmitting the electronic RFID tag's own recognition number and recognition number of objects included in each of a plurality of electronic RFID tags to the RFID recognition information checking server that contains the URI information of the RFID application server providing additional information, and receiving URI information corresponding to the transmitted electronic RFID tag's recognition number; and (h) being connected to the RFID recognition information checking server according to the received URI information, receiving information corresponding to the electronic RFID tag's recognition number transmitted from the RFID application server, and displaying the information on a reproduction screen.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating an electronic tag broadcasting system according to an embodiment of the present invention;

FIG. 2 is a flowchart of a broadcasting method using an electronic tag according to an embodiment of the present invention;

FIG. 3 is a block diagram of a broadcasting system according to an embodiment of the present invention;

FIG. 4 is a block diagram of a broadcasting signal input device illustrated in

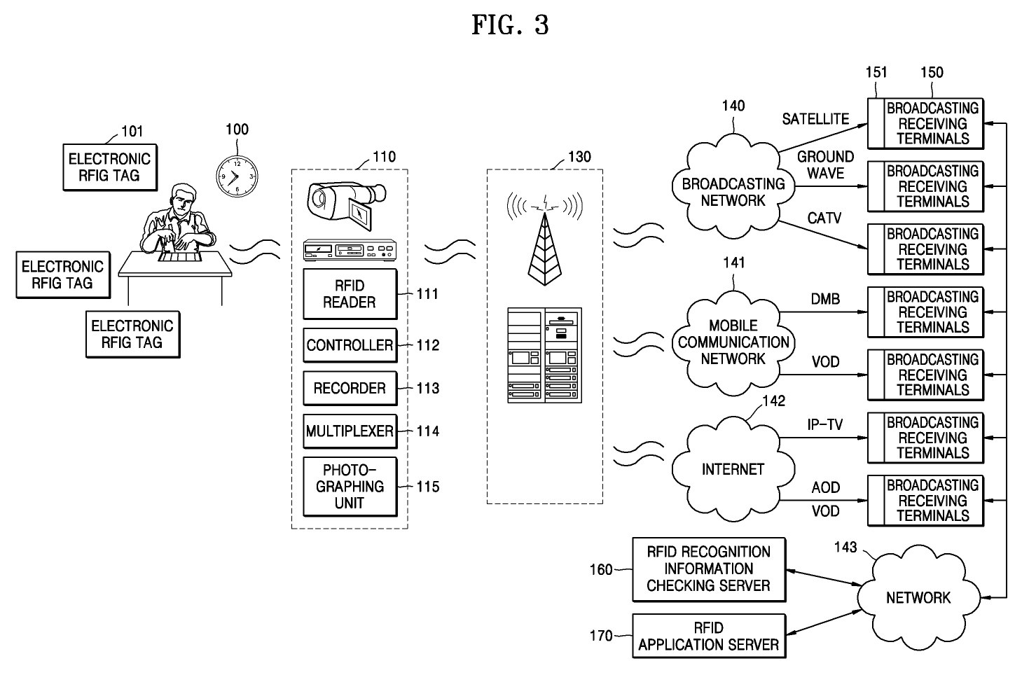

FIG. 3;

FIG. 5 is a block diagram of a detailed constitution of a RFID reader illustrated in FIG. 3;

FIG. 6 is a block diagram of a transmitter/receiver according to an embodiment of the present invention; and

FIG. 7 is a block diagram of a terminal that receives and processes a broadcasting signal according to an embodiment of the present invention;

### DETAILED DESCRIPTION OF THE INVENTION

Prior to the description of embodiments of the present invention, a web service technology and a radio frequency identification (RFID) system will now be described.

The web service technology refers to a technology for integrating diverse services provided by systems and applications using XML-based standards.

Standards are currently provided regarding information sources distributed on the Internet through HTTP, HTML, and URL technologies and information presentation methods. XML enables structured data to be transmitted on the Internet so that a lot of existing HTML-based information is newly processed as XML-based information, thereby marking a turning point in Internet technology.

Web services are called a web technology of services based on XML technology. Web services are interconnected using XML-based messaging standards, service technology standards, and transmission protocol standards.

The conventional web is a human-oriented environment providing users with XML-based information only, whereas web services are based on XML and use a simple object access protocol (SOAP) and a web services description language (WSDL), such that platforms and languages are neutrally developed and diverse automated applications are produced. Therefore, web services make it possible for any devices and programs to provide desired remote services through the SOAP, and are used as a part of services provided by devices and programs.

Accordingly, it is not necessary to develop web services or functions that are not provided by a client but web services that are being provided can be retrieved and used.

The advantage of web services introduces an Internet-based technology of integrating distributed applications, in particular, a web services-based service-oriented architecture (SOA). Many experts expect that the web services technology and SOA enable interactions between an automated program, and a program and device without a human operation.

The web services technology is further spotlighted in a ubiquitous environment in which a user is free to connect to a network and use devices regardless of where the user is without being aware of a computer or the network. Ubiquitous computing and network related technology are being developed all over the world. Research into diverse ubiquitous web services technologies are being conducted to apply the web services technology to ubiquitous environments.

Although a RFID tag which is an automatic recognition technology performs a similar function to barcodes and smart cards, it can recognize a long distance, serve as a shock-absorber, and recognize several objects simultaneously, thereby having the potential to be more widely applied than barcodes and smart cards. Even though RFID tags cost more than barcodes and less than smart cards and have a small memory capacity, unlimited possibilities of RFID tags has led to the development of various technologies.

A RFID system includes three elements, an antenna, a transponder/label, and a reader/writer and recognizes diverse objects without contacting them. In detail, the RFID system includes a transponder called an electronic tag, an electronic tag reader, and a host computer or a data processor. The electronic tag includes a semiconductor chip satisfying a variety of usage and requirements and an antenna receiving frequencies transmitted from the electronic tag reader.

The electronic tag passes through a valid range of frequencies of the antenna of the electronic tag reader, senses a signal transmitted from the electronic tag reader, and sends recognition information stored in the electronic tag to the electronic tag reader. The electronic tag reader includes a circuit that transmits/receives radio waves with the antenna and transmits the recognition information received from the electronic tag to the host.

The RFID is divided into read/write functions, whether or not a tag requires a power source, and an air interface exists between the reader and the tag.

TABLE 1

| RFID division by methods | | Main Features |
|---|---|---|
| Read/Write | Read Only | programmed when manufactured, |
| Functions | | information unchanged |
| of Tag | WORM | data programmed by a user, |
| | | programmed data unchanged |
| | Read/Write | frequent programming, data changed |
| Whether or | Active | battery attached to tag, communication |
| not Tag | | at a long distance of several tens meters |
| Requires | | expensive, lifetime restricted, used in |
| Power | | UHF band |
| Source | Passive | no battery attached to tag, communication |
| | | at a short distance below 10 m |
| | | Inexpensive, semi-permanent lifetime (more |
| | | than 10 years or so) |
| Radio | Below 135 | for facsimile and animal management at |
| Frequency | KHz | a short distance |
| Band | | inexpensive |
| | 13.56 MHz | for a short distance for IC cards, ID cards |
| | | high reliability in data transmission |
| | UHF | used in 433 MHz (active), |
| | | 860~960 MHZ bands |
| | | excellent in radio recognition performance |
| | | as compared with microwave band |
| | | ISO-A/B, EPC tag internationally utilized |
| | Microwave | used in ISM band of 2.45 GHz |
| | | low recognition rate in moisture and metal |
| | | environment as compared with UHF band |

| | |
|---|---|
| Others | divided into application (data/message), |
| | communication (between tag and reader), |
| | and transport (radio frequency band) |
| | according to application fields |

Tags are classified according to three methods, read-only, write once read many (WORM), and read/write according to their read/write functions. A read-only tag is programmed when manufactured, information included therein is not changed, and mainly used in a RFID application field that uses a simple recognition method owing to its low price. A WORM tag is programmed by a user and used in an application field capable of changing a program and data.

Tags are also classified into active tags and passive tags according to whether a signal oscillator is included in a tag. However, tags are classified into active tags that require a battery and passive tags that do not require a battery according to the classification in a narrow sense.

TABLE 2

| Classification | Active RFID | Passive RFID |
|---|---|---|
| Operation | tag can transmit | modify and reflect |
| | its RF signal power | signal of reader |
| | supplied by battery | power supplied |
| | | by frequency |
| | | signal of reader |
| Merit | long distance | no battery low price |
| | transmission | reduce battery |
| | (more than several | replacement expense |
| | tens meters) | |
| Demerit | price increased | Long distance transmission |
| | by battery operating | restricted (within |
| | time restricted | several meters) |
| | | addition of module like |
| | | sensors restricted |
| Application | Environment supervision, | Logistics management, |
| Field | military, medical, science | transportation, security, |
| | | electronic commerce, etc. |
| | will be used in | bar codes will be |
| | smart tags but are | replaced with low-priced |
| | high current prices | smart labels |

The present invention will now be described more fully with reference to the accompanying drawings, in which exemplary embodiments of the invention are shown.

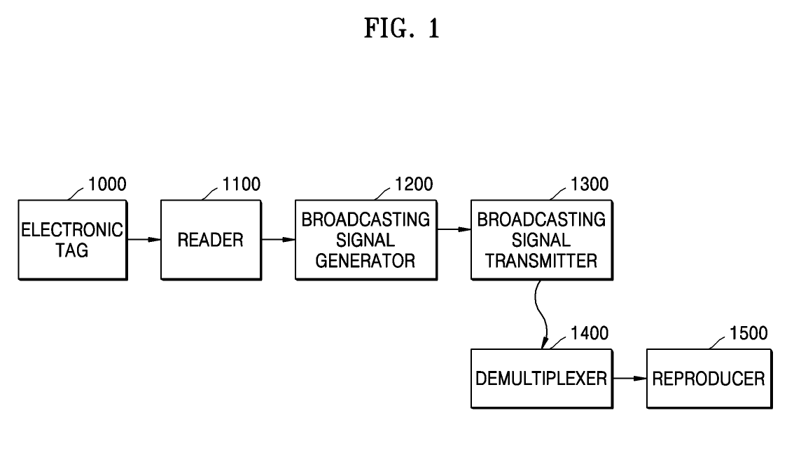

FIG. 1 is a block diagram illustrating an electronic tag broadcasting system according to an embodiment of the present invention. Referring to FIG. 1, the electronic tag broadcasting system includes an electronic tag 1000, a reader 1100, a broadcasting signal generator 1200, a broadcasting signal transmitter 1300, a demultiplexer 1400, and a reproducer 1500.

The electronic tag 1000 includes its own recognition number, stores information on an object neighboring the electronic tag 1000, and transmits its own recognition number and the information on the neighboring object when it senses a signal having a predetermined frequency band.

The reader 1100 outputs the signal having the predetermined frequency band and reads data from the electronic tag 1000 that responds to the signal so as to read information stored in the electronic tag 1000 corresponding to an object included in a screen obtained by photographing the object and its surroundings.

The broadcasting signal generator 1200 combines the photographed image and audio signal with the electronic tag's own recognition number and the data read from the reader 1100, multiplexes the combined information, and generates a broadcasting signal.

The broadcasting signal transmitter 1300 transmits the broadcasting signal generated by the broadcasting signal generator 1200 via a communication network including a satellite, a ground wave, a cable TV, digital multimedia broadcasting (DMB), a mobile communication network, and the Internet.

The demultiplexer 1400 receives the broadcasting signal and demultiplexes the broadcasting signal into an image, an audio signal, and electronic tag-related data.

The reproducer 1500 reproduces the demultiplexed image and audio signal and simultaneously displays information on the photographed object on a reproduction screen according to the electronic tag's own recognition number.

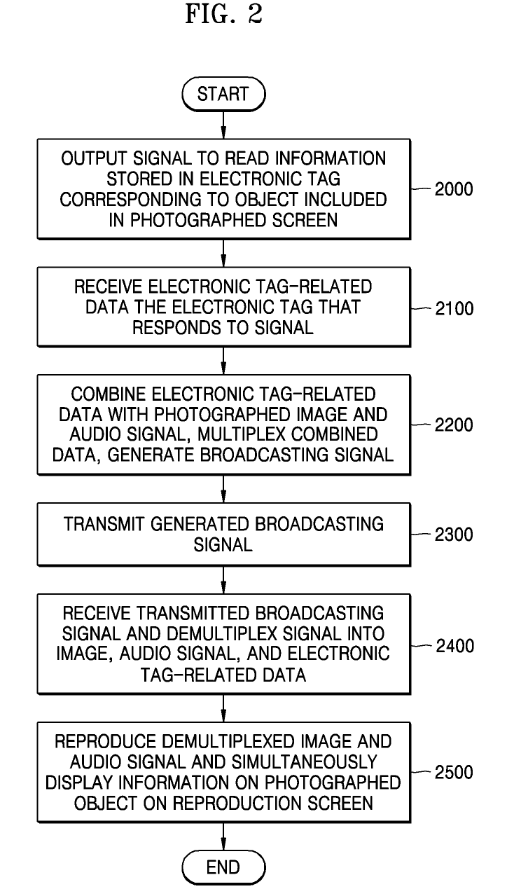

FIG. 2 is a flowchart of a broadcasting method using an electronic tag according to an embodiment of the present invention. In the broadcasting method an electronic tag is recognized that includes its own recognition number, information on an object neighboring the electronic tag is previously stored, and the electronic tag's own recognition number and the information on the neighboring object is transmitted if the electronic tag senses a signal having a predetermined frequency band.

Referring to FIG. 2, the signal having the predetermined frequency band is output to read information stored in the electronic tag corresponding to an object included in a screen obtained by photographing the object neighboring the electronic tag (Operation 2000).

Data is received from the electronic tag that responds to the signal having the predetermined frequency band (Operation 2100).

The electronic tag's own recognition number and the data read in Operation 2100 are combined with the photographed image and audio signal and multiplexed to generate a broadcasting signal (Operation 2200).

The broadcasting signal is transmitted via a communication network including a satellite, a ground wave, a cable TV, DMB, a mobile communication network, and the Internet (Operation 2300).

The broadcasting signal is received and demultiplexed into an image, an audio signal, and data on the electronic data (Operation 2400).

The demultiplexed image and audio signal are reproduced and simultaneously displays information on the photographed object on the reproduction screen according to the electronic tag's own recognition number, thereby providing uses with broadcasting (Operation 2500).

It is an object of the present invention to include objects photographed on a screen or information on photographing properties in a broadcasting signal. To this end, an electronic tag is attached to a photographed object whose information is included in the broadcasting signal. Information on the photographed object is in advance stored in the electronic tag. To prevent the electronic tag from being photographed, the information on the photographed object must be transmitted to the electronic tag via a non-contact route, i.e., a radio route, when the object is photographed.

The electronic tag preferably includes a RFID tag. The electronic RFID tag may use a variety of frequency bands, has a battery in active tags or no battery in passive tags, and can perform read-only, WORK, or read/write functions.

The information on the photographed object includes various contents. For example, the information includes a name, a material, a price, a selling place (e.g., a contact number, URL of an Internet site, etc.), a usage, etc. of the photographed object.

The electronic RFID tag 1000 preferably stores information on locations of an electronic tag and an object neighboring the electronic tag, so that information on a location of a photographing site is known.

The electronic RFID tag 1000 stores information on an object whose information is wanted to be included in the broadcasting signal. The electronic RFID tag 1000 is attached to the inside of the object, under the bottom of the object, near the object, or inside a wrapping of the object to prevent the electronic RFID tag 1000 from being exposed by a camera.

The electronic RFID tag 1000 includes its own recognition number, senses a signal having a predetermined frequency band if the signal is transmitted thereto, and transmits the electronic RFID tag 1000's own recognition number and previously stored information on a neighboring object.

The reader 1100 outputs a signal having a frequency band satisfying electronic RFID tag standards (Operation 2000) and reads data from the electronic RFID tag 1000 that responds to the signal (Operation 2100) so as to read information stored in the electronic RFID tag 1000 corresponding to an object included in a screen obtained by photographing the object and its surroundings. The reader 1100 is embedded in a camera, a camcorder, or a closed-circuit television (CCTV).

The reader 1100 preferably includes an antenna that transmits a command to the electronic RFID tag 1000 to request information from an electronic RFID tag as a signal having a uniform frequency band and receives a recognition number and information stored in the electronic RFID tag from the electronic RFID tag approaching the range of the frequency band, a transmitter that transmits the signal, which was transmitted to the electronic RFID tag 1000, having the frequency band to the antenna, a receiver that reads and recognizes the electronic tag information received from the antenna, and a recognition controller that converts the recognition information received by the receiver and the electronic tag information into digital data or extracts a signal containing the electronic tag information and controls the transmitter and the receiver to perform transmission/reception commands and the broadcasting signal generator 1200 to transmit/receive information.

A plurality of objects may be displayed on a photographed screen. A plurality of antennas, transmitters, and receivers correspond to a plurality of electronic RFID tags in order to simultaneously receive information from the plurality of the electronic RFID tags. The recognition controller preferably controls the antennas, the transmitters, and the receivers, recognizes the electronic RFID tags, and transmits/receives information.

Alternatively, the antennas may correspond to the plurality of electronic RFID tags. One transmitter, receiver, and recognition controller may be provided for the plurality of the antennas. Alternatively, one antenna transmits/receives signals to/from frequency regions of the plurality of electronic RFID tags and simultaneously receives information on a plurality of objects.

Each of the plurality of electronic RFID tags includes its own recognition information. Since the recognition information is transferred to the reader 1100, the reader 1100 can receive and process information on the plurality of electronic RFID tags without being confused.

Each of the embodiments as described can be understood by those of ordinary skill in the art to which the present invention pertains.

Security may be required to transmit/receive information between the electronic RFID tag 1000 and the reader 1100. To this end, a predetermined authentication and encoding method is preferably used to transmit/receive information between the electronic RFID tag 1000 and the reader 1100. The authentication and encoding method does not require a particular standard for the present invention but a variety of well-known methods can be used.

The detailed constitution and operation of the reader 1100 will now be described.

The broadcasting signal generator 1200 combines the electronic tag's own recognition number and the electronic tag-related data, which are read from the reader 1100, with the photographed image and audio signal, multiplexes the combined information, and generates a broadcasting signal (Operation 2200).

The broadcasting signal generator 1200 preferably performs time synchronization and encoding when combining the electronic tag's own recognition number and the electronic tag-related data, which are read from the reader 1100, and the photographed image and audio signal, so that a photographed screen and information on an object displayed on the photographed screen can be synchronized with the same time.

The “combining” may include encoding of a photographed image. Photographed video, recorded audio, and data received from an electronic RFID tag are encoded by a video encoder, an audio encoder, and a RFID encoder, respectively, and time synchronized by a time synchronizer and multiplexed.

The electronic tag broadcasting system illustrated in FIG. 1 preferably further includes a recorder that records or reproduces the broadcasting signal generated by the broadcasting signal generator 1200. It is necessary to watch results obtained by recording contents generated using the broadcasting signal and reproducing the recorded contents.

At this time, the broadcasting signal generator 1200 generates photographed contents as not video but a still screen called a still image. Information on an object included in the still image must be contained in the broadcasting signal to satisfy the subject matter of the present invention. To this end, the broadcasting signal generator 1200 preferably changes a photographed image signal to a still image including a JPEG image format and generates the changed image and the information read from the reader 1100 as meta data.

For example, the broadcasting signal generator 1200 stores location information of an area corresponding to the still image in a meta data field, which can be used as JPEG type information. That is, JPEG type information includes image data and meta data.

Although the electronic tag broadcasting system (reference numerals 1000, 1100, and 1200) for reading information from the electronic RFID tag 1000 and generating a broadcasting signal may be realized as illustrated in FIG. 1, another broadcasting signal generating system can be independently used.

The reader 1100 and the broadcasting signal generator 1200, not necessarily restricted thereto, can be used as a broadcasting photographing camera, a camcorder, etc. in the system.

If the broadcasting signal generator 1200 generates the broadcasting signal, the broadcasting signal transmitter 1300 transmits the generated broadcasting signal in which an image and audio data are combined with object information from the electronic RFID tag (Operation 2300). The broadcasting signal can be transmitted via a public broadcasting network including a satellite, a ground wave, and a cable TV, and DMB and video on demand (VOD) using a mobile communication network, or Internet protocol television (IP-TV), audio on demand (AOD), and VOD using the Internet.

In this regard, although photographed contents are immediately transmitted, it is natural that contents recorded by the recorder can be transmitted.

The demultiplexer 1400 demultiplexes broadcasting signals transmitted via various routes into the image, an audio signal, and electronic tag-related data including the object information (Operation 2400).

The reproducer 1500 reproduces the demultiplexed image and audio signal and simultaneously displays information on the photographed object on a reproduction screen according to the electronic tag's own recognition number (Operation 2500).

The reproducer 1500 preferably includes a video decoder, an audio decoder, and a RFID decoder that decode the image, audio signal, and electronic tag-related data demultiplexed in the demultiplexer 1400, respectively.

The demultipelxer 1400 and the reproducer 1500 can be realized as a system for receiving, demultiplexing, and encoding a broadcasting signal, e.g., TV, a settop box, a DMB device, an IP-TV, etc. That is, such a system can be independently realized only by including the demultipelxer 1400 and the reproducer 1500 except other constituents 1000, 1100, 1200, and 1300.

The system preferably further includes a recognition information manager/processor to separately manage the demultiplexed and decoded RFID recognition information using a predetermined method, which will be described later.

FIG. 3 is a block diagram of a broadcasting system according to an embodiment of the present invention, in which each of the constituents of the broadcasting system illustrated in FIG. 1 and additional services are included.

Suppose that a recognition number of an electronic RFID tag includes information on a photographed object which is stored in the electronic RFID tag.

Referring to FIG. 3, the broadcasting system includes an electronic RFID tag 101 that is attached to broadcasting contents and a material object 100, stores various information of each of a plurality of objects, and, when sensing a signal within a value frequency valid range, transmits information on the sensed signal, a broadcasting signal input device 110 comprising a RFID reader 111 that transmits the signal within a valid frequency range to read information recorded in the electronic RFID tag 101 or reads information from the electronic RFID tag 101 within the valid frequency range, a multiplexer 114 that combines information containing recognition information received from the RFID reader 111 with image/audio signals photographed and recorded by a photographing unit 115 and generates a broadcasting signal, a recorder 113 that records the broadcasting signal, and a controller 112 that internally controls the system. The broadcasting system also includes a broadcasting transmission system 130 that transmits the broadcasting signal including the recognition information of the electronic RFID tag 101 using a broadcasting network 140, a mobile communication network 141, and an Internet network 142, etc., a demultiplexer 151 that receives and demultiplexes the broadcasting signal including the recognition information of the electronic RFID tag 101, broadcasting receiving terminals 150 that receive electronic tag broadcasting using TV, a settop box, a DMB terminal, an IP-TV terminal that store recognition information, a RFID recognition information checking server 160 that is connected to the broadcasting receiving terminals 150 having the reproduction function and a communication network including the Internet, stores recognition numbers on objects included in each of electronic tags and universal resource identifier (URI) information on a RFID application server providing additional information relating to the recognition numbers, and, if the recognition information is input, transmits the URI information in response to the input recognition information, and a RFID application server 170 that, if information is requested according to the URI information transmitted from the RFID recognition information checking server 160, provides data corresponding to the recognition information in a manner of web services or conventional web technology. The broadcasting receiving terminals 150 display the information provided by the RFID application server 170 and video corresponding to the information on a screen.

The broadcasting signal input device 110 is a combination of the reader 1100 and the broadcasting signal generator 1200 illustrated in FIG. 1, the broadcasting transmission system 130 is the same as the broadcasting signal transmitter 1300 illustrated in FIG. 1, and the demultiplexer 151 and the broadcasting receiving terminals 150 are wholly or partially identical to the demultiplexer 1400 and the reproducer 1500 illustrated in FIG. 1.

As illustrated in FIG. 3, the electronic RFID tag 101 includes a memory that stores a lot of goods information including a manufacturing date, a place of origin, goods guarantee, a distribution flow, an expiry period, particulars, a producer, and the like, an antenna that receives a frequency transmitted from an antenna (211 of FIG. 6) of the RFID reader 111, a transmitter that, when a valid frequency signal is sensed, transmits information stored in the memory via the antenna, etc. The electronic RFID tag 101 is formed of a semiconductor chip satisfying diverse usages and requirements.

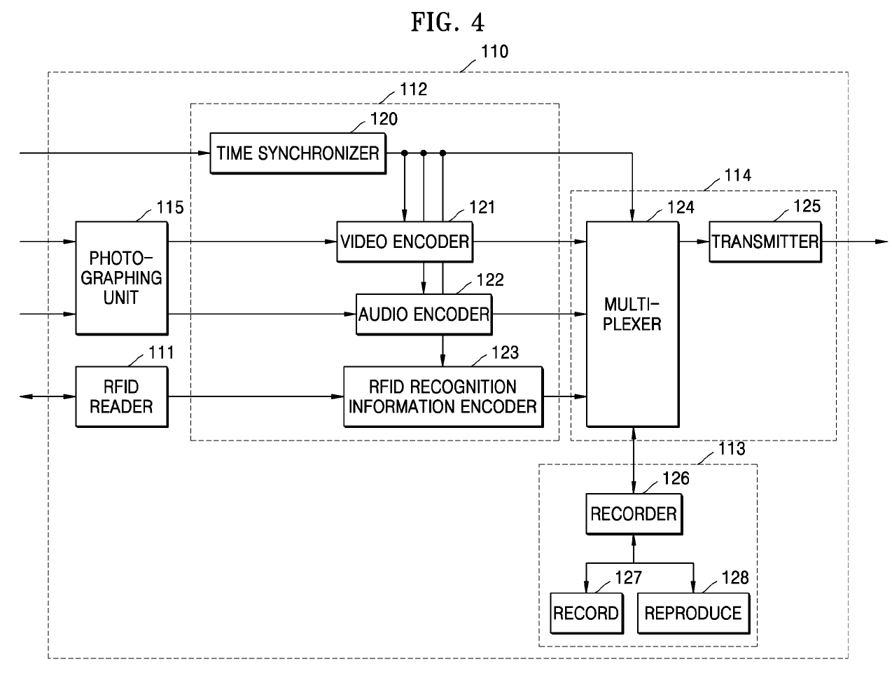

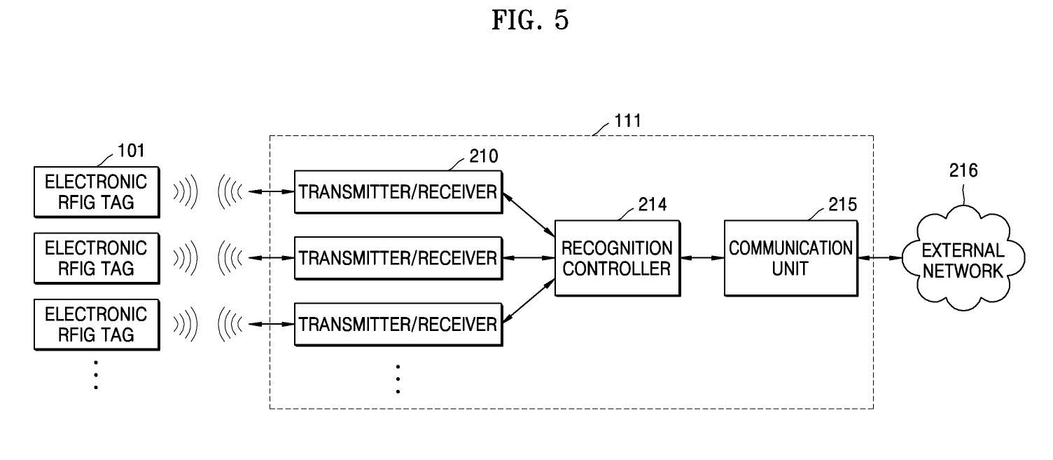

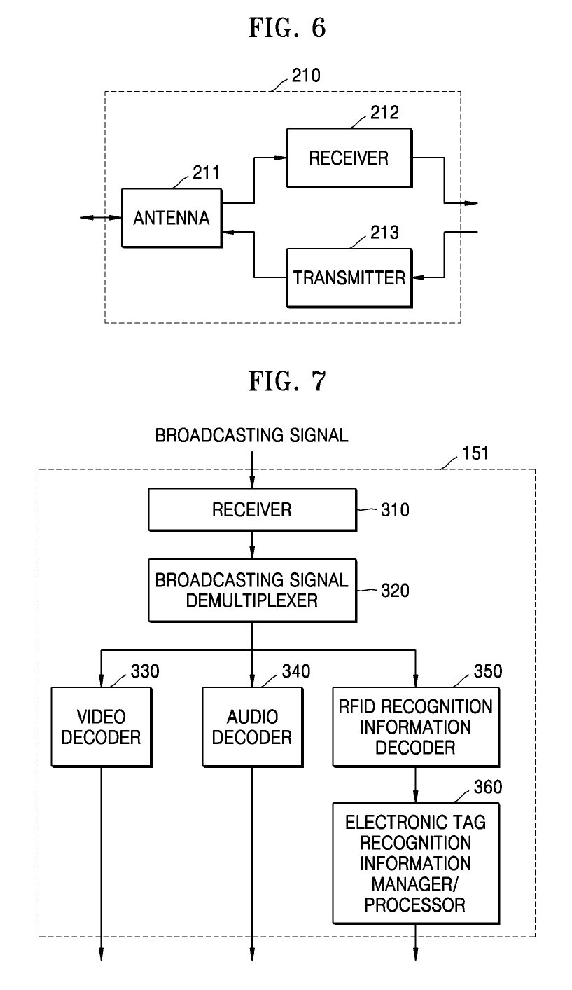

FIG. 4 is a block diagram of the broadcasting signal input device 110 illustrated in FIG. 3. Referring to FIG. 4, the broadcasting signal input device 110 includes the RFID reader 111 that transmits a signal within a valid frequency range to read information recorded in the electronic RFID tag 101 or reads information from the electronic RFID tag 101 within the valid frequency range, the photographing unit 115 that receives audio/image signals, a controller 112 that encodes 121, 122, and 123 the recognition information received from the RFID reader 111 and the audio/image signals received from the photographing unit 115, the multiplexer 114 that multiplexes using a multiplexer 124 and transmits via a transmitter 125 the encoded signals, and the recorder 113 that records 127 or reproduces 128 the received broadcasting signal, if necessary.

The controller 112 encodes each of image, audio, and recognition information signals via a video encoder 121, an audio encoder 122, and a RFID recognition information encoder 123. If time synchronization is required, a time synchronizer 120 performs time synchronization.

FIG. 5 is a block diagram of the RFID reader 111 illustrated in FIG. 3. Referring to FIG. 5, the RFID reader 111 includes a transmitter/receiver 210, a recognition controller 214, and a communicating unit 215. The transmitter/receiver 210 includes a transmitter 213 shown in FIG. 6 that transmits a command requesting information from the electronic RFID tag 101 to an antenna 211 shown in FIG. 6 to send the information in a uniform frequency signal to the electronic RFID tag 101, the antenna 211 shown in FIG. 6 that receives the information requested from the electronic RFID tag 101 approaching a valid frequency range using a non-contact and radio frequency method, a receiver 212 shown in FIG. 6 that receives the information on the electronic RFID tag 101 transmitted via the antenna 211. The recognition controller 214 converts the information or recognition information on the electronic RFID tag 101 received from the receiver 212 into digital information or transmits the information to the controller 112 of the broadcasting signal input device 110 shown in FIG. 4. The receiver 212 and the transmitter 212 process transmission/reception commands. The communication unit 215 that converts the recognition information on the electronic RFID tag 101 into more detailed information via an external network 216, if necessary.

FIG. 6 is a block diagram of a transmitter/receiver 210. The transmitter/receiver 210 includes an antenna 211, a receiver 212, and a transmitter 213.

FIG. 7 is a block diagram of a terminal that receives and processes a broadcasting signal according to an embodiment of the present invention. The terminal is a demultiplexing apparatus 151 for receiving electronic tag broadcasting that receives the broadcasting signal including recognition information on an electronic RFID tag transmitted from an electronic tag broadcasting system and separates the recognition information on the electronic RFID tag from the broadcasting signal in order to utilize the electronic tag broadcasting using the broadcasting receiving terminals 150 including a TV, a settop box, a DMB terminal, an IP-TV terminal and the like. Referring to FIG. 7, the demultiplexing apparatus 151 includes a receiver 310 that receives the broadcasting signal including recognition information on the electronic RFID tag, a broadcasting signal demultiplexer 320 that demultiplexes the broadcasting signal, a video decoder 330, an audio decoder 340, and a RFID recognition information decoder 350 that decode demultiplexed image, audio, and recognition information signals, respectively, and an electronic tag recognition information manager/processor 360 that maintains/manages and processes the RFID recognition information according to broadcasting.

The electronic tag recognition information manager/processor 360 communicates with the RFID recognition information checking server 160 and the RFID application server 170 illustrated in FIG. 3 to manage the RFID recognition information.

The operation of the electronic tag broadcasting system according to the present invention will now be described.

A broadcasting contents producer attaches the electronic RFID tag 101 for identifying objects to an object 100 that transmits recognition information and image/audio and receives the image/audio and recognition numbers of the electronic RFID tag 101 within a valid frequency range using the electronic tag broadcasting input device 110 including the RFID reader 111.

In detail, if the electronic RFID tags 101 attached to each of the objects 100 passes the valid frequency range transmitted from the antenna 211 via the transmitter 213 of the electronic tag broadcasting input device 110 including the RFID reader 111, the electronic RFID tags 101 senses a radio signal from the RFID reader 111 and sends information stored in the electronic RFID tags 101 to the RFID reader 111.

Thereafter, if the receiver 212 of the RFID reader 111 receives information of each of the objects 100 from the electronic RFID tag 101, the recognition controller 214 of the RFID reader 111 sends the information to the controller 112 of the electronic tag broadcasting input device 110 via the communication unit 215.

The controller 112 of the electronic tag broadcasting input device 110 encodes image and audio signals received via the photographing unit 115 and the information received via the RFID reader 111 having a plurality of the RFID readers 111 or the transmitters/receivers 210. The multiplexer 124 multiplexes the encoded data and transmits the multiplexed data to the broadcasting transmission system 130 via the transmitter 125 to send a broadcasting signal, i.e., broadcasting.

The broadcasting transmission system 130 transmits broadcasting using the networks 140, 141, and 142 to provide various broadcasting. The broadcasting receiving terminals 150 receive demultiplexed audio/image/recognition information from the demultiplexing apparatus 151 for receiving electronic tag broadcasting and decode them. The broadcasting receiving terminals 150 display the decoded result on a screen, check related information from the RFID recognition information checking server 160 automatically or using a user's input, or request related services from the RFID application server 170, thereby providing various services and application functions.

As described above, a recognition number indicating an electronic RFID tag is the electronic RFID tag's own information and is combined with information on a photographed object, thereby generating the photographed object's own information.

A RFID recognition number resulted from transmitting, demultiplexing, and decoding a broadcasting signal and information on a photographed object corresponding to the RFID recognition number may be the photographed object's own information. For example, when an object whose information is stored in an electronic RFID tag is a clock, and information on the object includes a manufacturing company, a model name, a manufacturing date, quality guarantee, size, price, a selling place of the clock, etc., the reproducer (1500 of FIG. 1) or the broadcasting receiving terminals (150 of FIG. 3) reproduce the screen ? and simultaneously display the clock information on the screen. Alternatively, the clock information is displayed on other screens. When information on each of a plurality of objects included in a screen is stored in each of a plurality of electronic RFID tags corresponding to the objects, all the information on the objects is simultaneously displayed on the screen. Likewise, information on a specific object that is selected by a user from a plurality of pieces of information can be displayed.

If there is information on an object included in a changed screen, information on the object is displayed on the changed screen.

A user can easily select the type of information on objects to be displayed on a screen, i.e., the screen to be active or inactive.

A user can obtain additional information on objects displayed on a photographed screen. For example, if information on an object includes information on where the object is located, the user can obtain information on a photographing place.

The present invention can be applied to a variety of applications such that additional information is provided to a user.

If a user wishes to purchase goods that information on an object displayed on a screen indicates, the user selects the information on the object to purchase the goods or selects a site selling the goods to obtain additional information on the goods from the site. Although such an embodiment is not disclosed, the embodiment can be realized using the broadcasting system according to the present invention.

When, after a reproduced screen is changed to another screen, a user wishes to see information on an object displayed on the reproduced screen, or search for a desired object among objects that appeared on a previous program, the electronic tag recognition information manager/processor 360 inquires about a recognition number of an electronic RFID tag and information on an object corresponding to the recognition number of the RFID recognition information checking server 160 or the RFID application server 170. The user logs on the servers 160 and 170 via the electronic tag recognition information manager/processor 360 and searches for necessary information, if desired.

Alternatively, a user can search for necessary information using a still screen or a still image generated from the broadcasting signal generator 1200 as described with reference to transmission of a broadcasting signal. The still screen or the still image includes information on an object included in the still image. Simultaneously with transmission of the broadcasting signal, the still screen is transmitted to the RFID recognition information checking server 160 or the RFID application server 170 via a network such as the Internet. Since the still screen includes the recognition number and information on objects, the servers 160 and 170 can identify the still screen from other still screens. Alternatively, information on a broadcasting program is included in the still screen, thereby additionally providing a user with a searching function.

When such derivative services are provided to a user, the RFID recognition information checking server 160 and the RFID application server 170 can store processed information on marketing or PR based on the recognition information and information on objects, and a database stored in the RFID recognition information checking server 160, respectively. It can be understood that the RFID recognition information checking server 160 and the RFID application server 170, which are divided in terms of functions can be integrated into a server.

Application services provided by the RFID recognition information checking server 160 and the RFID application server 170 of the present invention will now be described.

In previous embodiments, recognition information of an electronic RFID tag includes information on a photographed object to which the electronic RFID tag is attached.

However, since an electronic RFID tag has a restricted memory capacity, it may store an identification code or information on at least objects, analyze the identification code, obtain an additional information server address, and obtain more information from an additional information server.

For example, when surfing the Internet, a user uses an address www.etri.re.kr instead of an IP address, which is internally similar to a conversion of www.etri.re.kr into 129.254.122.11 via a domain name service (DNS).

To use a RFID recognition number included in an electronic RFID tag, the RFID recognition information checking server 160 contains a recognition code on objects included in each of electronic RFID tags and URI information on the RFID application server 170 providing additional information. If the recognition code is transmitted to the RFID recognition information checking server 160 via a network such as the Internet and a query regarding the RFID application server 170 is made, a URI address of the RFID application server 170 is returned.

In this case, the operating method is similar to a DNS method and its standard is already known.

The URI address of the RFID application server 170 is, for example, http://www.etir.re.kr/uri.html, which provides a user with resources requested by the user in web services or conventional web technology.

The RFID application server 170 provides various additional information in the form of a database and an independent data schema. For instance, the RFID application server 170 provides web services in the form of an XML-based SOAP message. A broadcasting producer may input or process information on a photographed object to which an electronic RFID tag is attached in the RFID application sever 170.

In detail, as an embodiment of the present invention, information on object recognition is received from an electronic RFID tag. The information is transmitted to the RFID recognition information checking server 160 to make a query. The RFID recognition information checking server 160 checks information on the RFID application server 170 corresponding to a recognition code. If a server corresponding to the information on the RFID application server 170 is checked, the RFID recognition information checking server 160 transmits information on an address of the server. A terminal connected to the RFID recognition information checking server 160 requests information from the RFID application server 170 using the address information.

In the current embodiment, the recognition number of the electronic RFID tag is only combined with a broadcasting signal. Information on the photographed object to which the electronic RFID tag is attached is, for instance, previously processed by the broadcasting producer and stored in the RFID application server 170. The demultiplexing apparatus 151 for receiving electronic RFID tag broadcasting that received the recognition number of the electronic RFID tag transmits the recognition number of the electronic RFID tag to the RFID recognition information checking server 160 via a network such as the Internet 143, makes a query, searches for the RFID application server 170, connects to the RFID application server 170 again, receives application information which is additional information corresponding to the recognition number of the electronic RFID tag, and provides a user with the application information via the broadcasting receiving terminals 150.

In this regard, it can be understood that the user searches for additional information on the object to which the electronic RFID tag is attached corresponding to the previously selected and received recognition number of the electronic RFID tag, or does not search for the additional information.

After Operation 2500 shown in FIG. 2, the demultiplexing apparatus 151 for receiving electronic RFID tag broadcasting transmits the electronic RFID tag's own recognition number to the RFID recognition information checking server 160 that contains the URI information of the RFID application server 170 providing additional information by combining the electronic RFID tag's own recognition number with recognition numbers of objects included in each of a plurality of electronic RFID tags, receives URI information corresponding to the transmitted electronic RFID tag's own recognition number, connects to the RFID recognition information checking server 160 according to the received URI information, receives information corresponding to the electronic RFID tag's own number transmitted from the RFID application server 170, and displays the information on a reproduced screen.

Consequently, the present invention uses information on an object by reading a recognition number of an electronic RFID tag and the information on the objects, and uses additional information from a server that stores the additional information corresponding to the recognition number of the electronic RFID tag. In the latter, URI information of the RFID application server 170 is obtained from the RFID recognition information checking server 160 containing data which converts the recognition number into an address of the RFID application server 170 providing additional information and containing substantial information on the recognition number.

Various additional services can be provided using information obtained from the present invention.

Information on objects displayed on a screen is provided using caption services. In this case, a scenario regarding the objects displayed on the screen is previously prepared for the caption services, thereby providing a similar result to the present invention. For instance, it can be understood that although information on an object, which is selected by a broadcasting player from several tens of objects can be easily displayed on the screen using the present invention, it is impossible to automatically provide information on object using the caption services.

Also, an antitheft and security system can be realized by attaching an electronic tag recognition apparatus including the electronic tag 1000, the reader 1100, the broadcasting signal generator 1200, and the broadcasting signal transmitter 1300 shown in FIG. 1 to a CCTV, establishing the CCTV in a specific area, and recording an image captured by the CCTV and an electronic tag signal.

It can be easily understood by those of ordinary skill in the art that each of the operations according to the present invention can be realized in the form of software or hardware using a general programming method.

The present invention can also be embodied as computer readable code on a computer readable recording medium. The computer readable recording medium is any data storage device that can store data which can be thereafter read by a computer system.

Firstly, in a broadcasting technology, although intellectual bi-directional broadcasting is required to provide various object information including for example a hero's costume, accessories, furniture, etc., which are included in a currently broadcast image, there is no conventional technical method to automatically input a variety of additional information, which can be solved by the present invention.

Secondly, since an electronic RFID tag including a memory can store a lot of goods information including a manufacturing date, a place of origin, goods guarantee, a distribution flow, an expiry period, particulars, a producer, and the like, and transmit the recognition information along with audio and image information, the present invention can provide additional broadcasting applications and services that automatically update additional services and data regarding various objects and contents included in broadcasting images and audio.

Thirdly, the present invention can easily combine identification information on several locations and facilities included in an electronic tag with audio and images via a broadcasting inputting device including an electronic tag reader and provide the combined information, thereby promoting the production of broadcasting contents including various additional information and accelerating the combination of telecommunication/broadcasting to provide users with a more convenient life.

Fourthly, an individual or entrepreneur is free to use a camcorder or a CCTV which are modifications of the broadcasting inputting apparatus including the electronic tag reader in order to record and reproduce images and audio including information on an electronic RFID tag that contains information on locations, sightseeing, transportation, and goods, and record image signals including RFID recognition information in an antitheft and security system, resulting in the development of broadcasting applications including various information on electronic RFID tags.

Fifthly, a broadcasting receiving terminal such as a TV, a settop box, a DMB terminal, or an IP-TV terminal receives a broadcasting signal that stores recognition information on an electronic tag obtains detailed information by selecting a desired object from information on various objects displayed on a screen, or uses intellectual broadcasting services, e.g., the purchase of goods via electronic commerce. Furthermore, the broadcasting receiving terminal provides combined information services, e.g., the actual purchase of goods appearing on broadcasting commercials or soap operas, or the search of combined sightseeing information in sightseeing guide broadcasting.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An electronic tag broadcasting system, comprising:
an electronic tag comprising a recognition number and, when sensing a signal having a predetermined frequency band, transmitting the recognition number;
a reader outputting the signal having the predetermined frequency band and reading data from the electronic tag that responds to the signal so as to read information stored in the electronic tag corresponding to an object included in a screen obtained by photographing the object and its surroundings; and
a broadcasting signal generator combining the photographed image and an audio signal with the electronic tag's own recognition number and the data read from the reader, multiplexing the combined information, and generating a broadcasting signal.

2. The system of claim 1, wherein the electronic tag transmits information on an object neighboring the electronic tag if the information is previously stored in the electronic tag,
wherein the reader reads the information on the neighboring object, and wherein the broadcasting signal generator combines the information on the neighboring object with the photographed image, the audio signal, and the electronic tag's own recognition number, multiplexes the combined information, and generates the broadcasting signal.

3. The system of claim 1, wherein the electronic tag comprises a radio frequency identification (RFID) tag.

4. The system of claim 1, wherein the broadcasting signal generator performs time synchronization and encoding when combining the image, and the audio signal with the information read from the reader.

5. The system of claim 1, further comprising: a recorder recording or reproducing the broadcasting signal generated by the broadcasting signal generator.

6. The system of claim 1, wherein the reader comprises:
an antenna transmitting a command to the electronic RFID tag to request information from an electronic RFID tag as a signal having a uniform frequency band and receiving a recognition number and information stored in the electronic RFID tag from the electronic RFID tag approaching the range of the frequency band;
a transmitter transmitting the signal, which was transmitted to the electronic RFID tag, having the frequency band to the antenna;
a receiver reading and recognizing the electronic tag information received from the antenna; and
a recognition controller converting the recognition information received by the receiver and the electronic tag information into digital data or extracting a signal containing the electronic tag information and controlling the transmitter and the receiver to perform transmission/reception commands and the broadcasting signal generator to transmit/receive information.

7. The system of claim 6, wherein the antenna, the transmitter, and the receiver are plural corresponding to a plurality of electronic tags,
wherein the recognition controller controls the plurality of antennas, transmitters, and receivers to recognize the plurality of electronic tags and transmits/receives information.

8. The system of claim 6, wherein the antenna is plural corresponding to a plurality of electronic tags.

9. The system of claim 1, wherein the electronic tag and the reader communicates information using a predetermined authentication and encoding method.

10. The system of claim 1, wherein the information stored in the electronic tag comprises information on locations of the electronic tag or an object neighboring the electronic tag.

11. The system of claim 1, wherein the broadcasting signal generator changes the photographed image signal to a still image including a JPEG image format and generates the changed image and the information read from the reader as a meta data image.

12. The system of claim 1, further comprising: a broadcasting signal transmitter transmitting the broadcasting signal generated by the broadcasting signal generator via a communication network including a satellite, a ground wave, a closed-circuit TV (CCTV), digital multimedia broadcasting (DMB), a mobile communication network, and an Internet network.

13. An electronic tag broadcasting system that receives a broadcasting signal obtained by encoding a recognition number of an electronic tag neighboring a photographing object and electronic tag related data which is information on the photographing object stored in the electronic tag along with a photographing image and an audio signal, multiplexing the encoded data, and transmitting the multiplexed data, the broadcasting system comprising:
a demultiplexer receiving the multiplexed broadcasting signal and demultiplexing the received broadcasting signal into an image, an audio signal, and electronic tag-related data; and
a reproducer reproducing the demultiplexed image and audio signal and simultaneously displaying information on the photographed object on a reproduction screen according to the electronic tag's recognition number.

14. The system of claim 13, wherein the reproducer comprises: a video decoder, an audio decoder, and a RFID decoder that decode the image, audio, and electronic tag-related data demultiplexed in the demultiplexer, respectively.

15. The system of claim 14, wherein the reproducer further comprises: a recognition information manager/processor separately managing the demultiplexed and decoded RFID recognition information using a predetermined method.

16. The system of claim 15, further comprising:
an RFID recognition information checking server connected to the recognition information manager/processor via a communication network including the Internet, storing recognition numbers on objects included in each of a plurality of electronic tags and universal resource identifier (URI) information on an RFID application server providing additional information relating to the recognition numbers, and, if RFID recognition information is input via the recognition information manager/processor, transmitting the URI information in response to the input RFID recognition information; and
the RFID application server providing data corresponding to the RFID recognition information in a manner of web services or web at the request of the recognition information manager/processor connected to the RFID recognition information checking server according to the URI information.

17. A broadcasting method of recognizing an electronic tag that comprises a recognition number, previously stores information on an object neighboring the electronic tag, and, when sensing a signal having a predetermined frequency band, transmitting the electronic tag's recognition number and the information on the object neighboring the electronic tag, the method comprising:
(a) outputting the signal having the predetermined frequency band so as to read information stored in the electronic tag corresponding to an object included in a screen obtained by photographing the object neighboring the electronic tag;
(b) receiving electronic tag related data from the electronic tag in response to the signal having the predetermined frequency band;
(c) combining the photographed image and an audio signal with the electronic tag's own recognition number and the electronic tag related data received in operation (b), multiplexing the combined information, and generating a broadcasting signal;
(d) transmitting the generated broadcasting signal via a communication network including a satellite, a ground wave, a CCTV, DMB, a mobile communication network, and an Internet network;
(e) receiving the transmitted broadcasting signal and demultiplexing the received signal into an image, an audio signal, and electronic tag-related data; and
(f) reproducing the demultiplexed image and audio signal and simultaneously displaying information on the photographed object on a reproduction screen according to the electronic tag's own recognition number.

18. The method of claim 17, further comprising:
(g) transmitting the electronic RFID tag's own recognition number and recognition number of objects included in each of a plurality of electronic RFID tags to the RFID recognition information checking server that contains the URI information of the RFID application server providing additional information, and receiving URI information corresponding to the transmitted electronic RFID tag's recognition number; and
(h) being connected to the RFID recognition information checking server according to the received URI information, receiving information corresponding to the electronic RFID tag's recognition number transmitted from the RFID application server, and displaying the information on a reproduction screen.
